(19) United States
(12) Patent Application Publication
(10) Pub. No.: US 2015/0178312 A1
(43) Pub. Date: Jun. 25, 2015

(54) ATTRIBUTE-BASED ASSISTANCE REQUEST SYSTEM FOR SEQUENTIALLY CONTACTING NEARBY CONTACTS WITHOUT HAVING THEM DIVULGE THEIR PRESENCE OR LOCATION

(71) Applicant: LSI Corporation, San Jose, CA (US)

(72) Inventors: Sandeep Pant, Orefield, PA (US); David L. Dreifus, Clinton, NJ (US)

(73) Assignee: LSI Corporation, San Jose, CA (US)

(21) Appl. No.: 14/177,646

(22) Filed: Feb. 11, 2014

Related U.S. Application Data
(60) Provisional application No. 61/919,141, filed on Dec. 20, 2013.

(51) Int. Cl. G06F 17/30; H04L 29/08

(52) U.S. Cl. CPC G06F 17/30241; G06F 17/30424; H04L 67/10

(57) ABSTRACT

An anonymous non-emergency help system matches capabilities of potential helpers to a requestor's needs. Helpers identify the type of assistance they are willing to provide and then agree to become available anonymously. The helpers are contacted sequentially for assistance based on proximity to the requestor. The nearest helper may choose to respond or decline the request. This anonymous location process occurs sequentially, awaiting a requestor-defined timeout, until one of the identified individuals agrees to fulfill the request or until there are no other proximate individuals that meet the specific request criteria. A call for help is not broadcast, but helpers are chosen based on their disclosed skills/capabilities, attributes, and their proximity to the requestor. The attributes are related to at least one of speed and trajectory relative to the requestor, time the helper is in a particular location, and altitude difference between the requestor and the helper.

### CROSS-REFERENCE TO RELATED APPLICATIONS

This application claims the benefit of the filing date of U.S. Provisional Patent Application Ser. No. 61/919,141, filed on 20 Dec. 2013, the teachings of which are incorporated herein by reference in its entirety.

### BACKGROUND

1. Field of the Invention

The present invention relates to information systems generally and, more specifically, to an Internet-based assistance request system and methods of operating same.

2. Description of the Related Art

Cellphone coverage and use is ubiquitous. A cellphone has transformed from a voice only device to a multi-functional converged smartphone with multimedia, data, networking, and physical locating capabilities amongst many of the smartphone's features.

Users may sometimes voluntarily publish their location and activities such as Checking In with Facebook or via many other applications that allow the users to locate other smartphone users. Other similar exemplary applications include, “Family Phone Locator” offered by Verizon, iPhone applications such as “Find iPhone” and “Find My Friends”, “EchoEcho”, Facebook Messenger, etc. These and other so-called “geo-social” networking applications enable users to publish their location and can also be used to identify all contacts, or in some cases unknown but interested individuals, which are proximate and have elected to be “visible” to other users.

These applications are focused towards social interactions and the users are therefore alerted to the presence of other local “visible” users. For example, this feature enables a user to send requests to a single individual or multicast it to a group to assemble at a particular location.

Once the user is aware that there are identified individuals in the area, those individuals' privacy is compromised. To avoid this, those individuals might switch status from “visible” to “invisible”.

In addition, not all requests are suitable or appropriate for distribution to all visible contacts. Furthermore these requests are made without consideration of a contact's capability to address a specific request or concern for immediate privacy. For example a contact may be temporarily indisposed and unable to reply let alone address a specific request.

At times a smartphone user might need help (assistance) other than a life threatening “911” issue requiring emergency personnel, such as to locate a friend or colleague nearby for a specific task. In this situation, the smartphone user needs the ability to locate a capable and willing contact in close proximity to the user (the “requestor”), rather than having to call contacts (potential helpers) at random who might be unavailable, unable, unwilling, or too far away to be of immediate help. Also what is needed is a way to avoid requesting more help than is required and to provide feedback to the requestor and potential helpers about the status of a help request.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Described embodiments include a method comprising the steps of receiving, from a requestor, a request for assistance for a specified task; selecting, from a list of contacts, contacts based on the request for assistance for the specified task using keywords of the request compared against capabilities of the contacts on the list of contacts; determining physical locations of the requestor and one or more of the selected contacts; identifying, from the selected contacts, one or more potential contacts based on physical distance between the one or more selected contacts and the requestor; calculating an attribute for each of the one or more potential contacts having a determined physical location; selecting, from the one or more potential contacts having a calculated attribute, a set of one or more viable contacts based on a comparison between the calculated attribute and a requestor-defined limitation; and forwarding the request for assistance to the one or more selected viable contacts. The attribute is at least one of: speed of the potential contact having a determined physical location, trajectory of the potential contact having a determined physical location with respect to the physical location of the requestor, altitude of the potential contact having a determined physical location with respect to the physical location of the requestor, and residence time of the potential contact at a determined physical location.

### BRIEF DESCRIPTION OF THE DRAWING FIGURES

Other aspects, features, and advantages of the present invention will become more fully apparent from the following detailed description, the appended claims, and the accompanying drawings in which like reference numerals identify similar or identical elements.

FIG. 1 shows a simplified block diagram of a system for sequential request for assistance from nearby contacts without having them divulge their presence or location in accordance with embodiments of the invention;

FIG. 2 shows an exemplary logical diagram of the system shown in FIG. 1 in accordance with embodiments of the invention.

FIG. 3A shows an exemplary list of a basic setup for all contacts stored in the system shown in FIG. 1 in accordance with embodiments of the invention;

FIG. 3B shows an exemplary list of an access configuration for each contact shown in FIG. 3A in accordance with embodiments of the invention;

FIG. 3C shows an exemplary list of a contact configuration for each contact shown in FIG. 3A in accordance with embodiments of the invention;

FIG. 4 shows an exemplary list of a requestor's setup/configuration for assistance requests from nearby contacts in accordance with embodiments of the invention;

FIG. 5 shows an exemplary “screen shot” of a requestor's device display when a request is placed in accordance with embodiments of the invention;

FIG. 6 shows an exemplary “screen shot” of a potential helper's device display when a request is placed in accordance with embodiments of the invention;

FIG. 7A shows an exemplary “screen shot” of a requestor's device display when a request is accepted by a helper in accordance with embodiments of the invention;

FIG. 7B shows an exemplary “screen shot” of a helper's device display when a request is accepted by the helper in accordance with embodiments of the invention;

FIG. 8A shows an exemplary “screen shot” of other potential helpers' device display when a request is addressed by one helper in accordance with embodiments of the invention;

FIG. 8B shows an exemplary “screen shot” of a requestor's device display when no helper can be found in accordance with embodiments of the invention;

FIG. 9 shows a flowchart of an exemplary method for requesting for help through the system shown in FIG. 1 in accordance with embodiments of the invention;

FIG. 10 shows a flowchart of an exemplary method for steps to determine certain attributes of potential helpers and referred to as a step in the flowchart of FIG. 9 in accordance with embodiments of the invention; and

FIG. 11 shows a flowchart of an exemplary method for installation and initial setup of the system shown in FIG. 1 in accordance with embodiments of the invention.

### DETAILED DESCRIPTION

Reference herein to “one embodiment” or “an embodiment” herein means that a particular feature, structure, or characteristic described in connection with the embodiment can be included in at least one embodiment. The appearances of the phrase “in one embodiment” in various places in the specification are not necessarily all referring to the same embodiment, nor are separate or alternative embodiments necessarily mutually exclusive of other embodiments. The same applies to the term “implementation”.

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. In addition, the articles “a” and “an” as used in this application and the appended claims should generally be construed to mean “one or more” unless specified otherwise or clear from context to be directed to a singular form.

Described embodiments relate to a system and method for sequential requests for assistance from nearby contacts without having them divulge their presence or location.

In the described embodiments, a list of contacts may be generated and stored in a server of the system. At the outset, the contacts would agree to have their location determined when needed but not divulged to anyone. Once the requestor summons a request for help for a specified task, an application executed by the server determines the closest contact to the requestor capable of addressing the specified request by matching the request to the capabilities of the contacts as potential helpers, calculating one or more attributes to determine whether a contact should be considered viable, and sends to the closest contact a communication informing them of the request for help from the requestor. The calculated attribute includes at least one of the following: speed, trajectory, altitude, and residence time. The closest contact may choose to respond or decline the request. The application then contacts the next closest viable contact to the requestor when the closest viable contact does not respond or declines and so on. The contacts may retain their anonymity. The requestor may never know who was contacted or who was available but ignored or declined the requestor's request for help.

Note that herein, the terms “helper”, “potential helper”, “contact”, “individual”, and “person” may be used interchangeably. It is understood that a helper or potential helper may correspond to, or relate to, a contact, or an individual, or a person, and that the contact, the individual, or the person may refer to the helper or a potential helper. Similarly, the terms “help” and “assistance” may be used interchangeably.

Note that herein, the terms “application”, and “server” may be used interchangeably. It is understood that an application may correspond to, relate to, or be executed by a server, and that the server may refer to the application. Further, the plural of certain terms, such as contacts, may also refer to non-plural instances of the term.

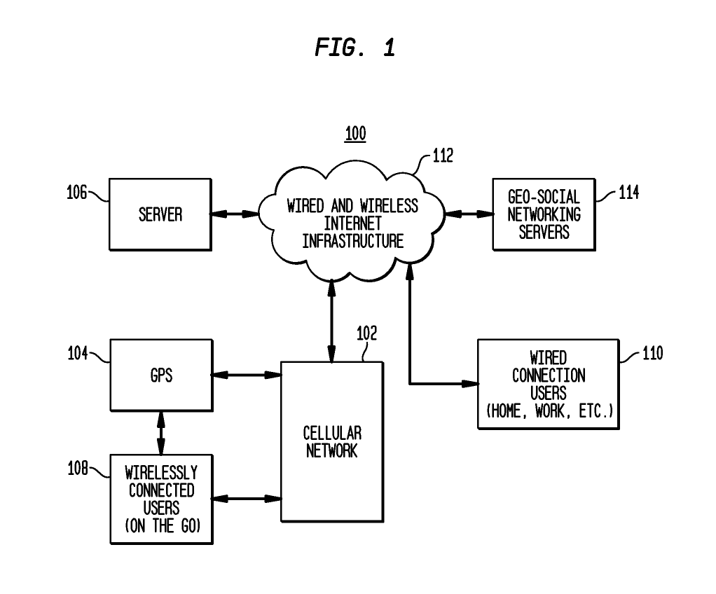

FIG. 1 shows a simplified block diagram of a system for sequential request for assistance from nearby contacts without having them divulge their presence or location in accordance with embodiments of the invention. As shown, system 100 includes cellular network 102 that connects to GPS 104, wirelessly connected users 108 and wired connected users 110 within wired/wireless internet infrastructure 112. Help server 106 and geo-social networking servers 114 are connected to system 100 through wired/wireless Internet infrastructure 112. Exemplary geo-social networking servers 114 include Facebook, Google+, etc., which might be used to determine a users' physical location.

Cellular network 102 is a well-known wireless network distributed over land areas called cells, each served by at least one fixed-location transceiver, known as a cell site or base station (not shown). In cellular network 102, each cell might use a different set of frequencies or spreading codes from neighboring cells to avoid interference between cells and provide a minimum data capacity within each cell. When joined together, these cells provide radio coverage over a wide geographic area. This enables a large number of portable transceivers (e.g., mobile phones, tablet computers, pagers, etc.) to communicate with each other and with fixed transceivers and telephones anywhere in cellular network 102 via the base stations (cell sites) even if some of the transceivers are moving through more than one cell during transmission. As shown in FIG. 1, GPS 104, server 106, wirelessly connected users 108, wired/wireless internet infrastructure 112, and wired connected users 110 communicate with the cellular network 102.

Server 106 is a system including software and suitable computer hardware that responds to requests across cellular network 102 to provide, or help to provide, a network-based assistance request service. Conventional server 106 can be a dedicated computer or a networked group of computers. Server 106 operates with the wired/wireless Internet infrastructure 112. Server 106 provides an assistance request service, as described below, across cellular network 102, either to wirelessly connected users 108 or wired connected users 110. The server 106 stores a requestor's contacts and executes applications performing assistance request operations, such as calculating locations of all users including the requestor and potential helpers (contacts) and attributes of requestor's contacts, determining potential helpers and the closest contact to the requestor, and forwarding the request to the closest contact, etc.

Wirelessly connected users 108 may be mobile objects, such as people on the go, automobiles running on the road, etc. In one embodiment, wirelessly connected users 108 may be a smartphone user or a tablet computer with wireless data connectivity. Wired connection users 110 may be a computer at home or at work, and so on.

At times the smartphone user might need help and needs to locate a friend or colleague nearby for a specific task. The nature of help could be non-life threatening and not warrant “911” assistance. The following exemplary scenarios might necessitate such help with system 100:
Car needs a jumpstart;
Locked out of the house;
Need help moving heavy objects;
Need babysitting help; and
Transport of item requiring a truck.

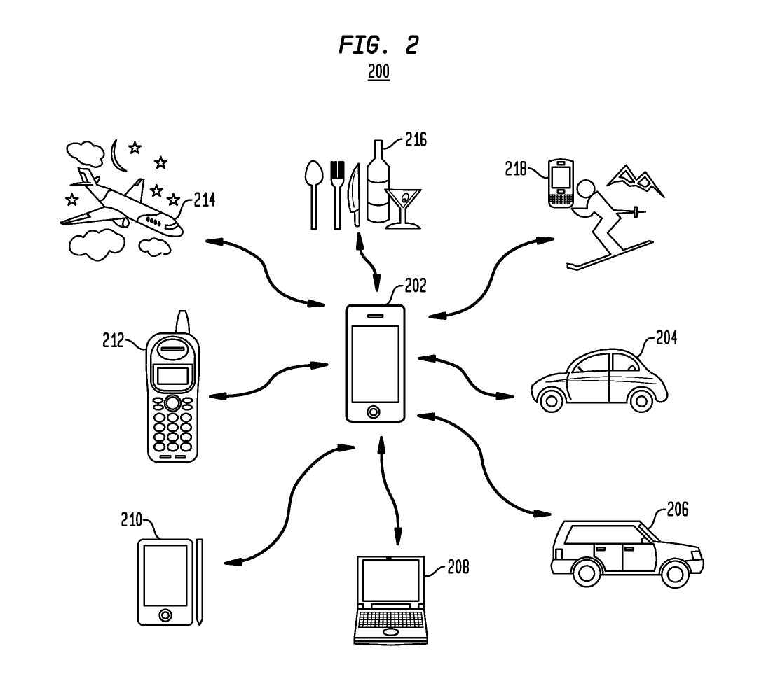

FIG. 2 shows an exemplary logical diagram of the system 100 shown in FIG. 1 in accordance with embodiments of the invention. The diagram 200 includes requestor 202 using a mobile phone and a plurality of selected contacts-potential helpers, i.e., potential helpers 204-218 that are selected from requestor's 202 contact list based on a request for help by the requestor 202. Here, some of the selected contacts from requestor's 202 contact list are confirmed as potential helpers, and located at different distances or paths from requestor 202 and might be at different situations. For example, potential helper 204 is in a car driving towards requestor 202, potential helper 206 is in a truck driving away from requestor 202, potential helper 208 is using a laptop sitting in office or home, potential helper 210 is using a tablet computer and might or might not be moving, potential helper 212 is using a cell phone and might or might not be moving, potential helper 214 is in an airplane flying at a certain height above the requestor, potential helper 216 is eating in restaurant, and potential helper 218 is on vacation with his/her cell phone. When a request for help for a specific task is sent out from requestor 202, the request for help is forwarded to a potential helper closest to the requestor determined by server 106 in system 100. As shown in FIG. 2, for example, the request may be forwarded to helper 216 that “checked-in” to a restaurant via a geo-social networking application or website, assuming their residence time is less than a day. Otherwise, the request may be sent to helper 204 that is the next closest contact to requestor 202. Note that the requestor and the potential helpers all are users of the system, and a helper is a contact in the requestor's contact list.

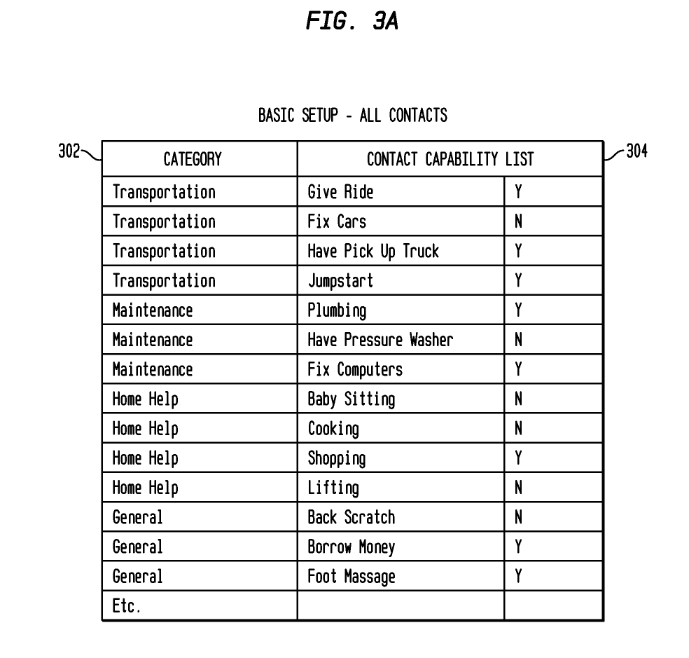

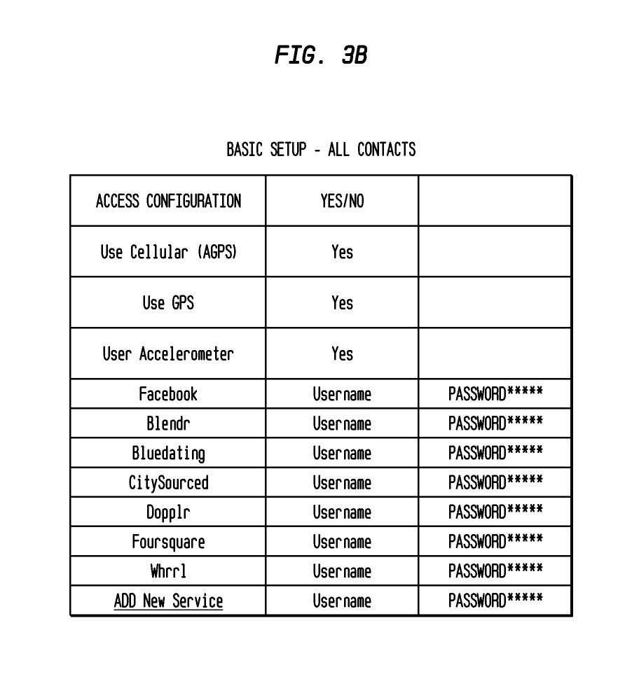

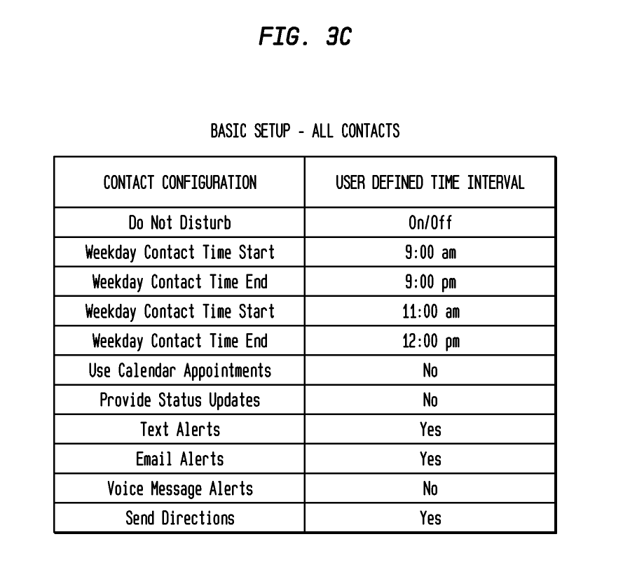

FIGS. 3A-3C show an exemplary list of a basic setup for all contacts stored in the server shown in FIG. 1 including category, contact capability list, access configuration, and contact configuration of each contact. In one embodiment, a contact list containing the requestor's friends, neighbors, or family is stored in the requestor's smartphone and downloaded to the server 106. FIG. 3A shows a basic setup for all requestors' contacts each contact including category 302 and contact attribute list 304. The basic setup contains those individuals' capabilities/skills in performing a range of tasks and willingness to provide assistance when requested. This is expected to be fluid over time as new capabilities are added or existing capabilities lost such as a purchase or sale of a truck for moving heavy objects. FIG. 3B shows access configuration for each contact. For example, some contacts may be located by global positioning system (GPS), other contacts might be located by the well-known cell site triangulation technique, some contacts may be located through Facebook, etc. Access configurations are also listed if the requestor's contacts are username and password protected. FIG. 3C shows a contact configuration menu that includes the availability of the contact and method of an alert to this contact, and so on. For example, as shown, this contact will provide help on weekend starting at 11 am and ending at 12 pm, and this contact can be contacted through text messages and emails, but not voice messages, and this contact accepts directions. The contact configuration as shown in FIG. 3C includes preferred modality of communication, such as telephone (voice), text, or email. When a contact agrees to assist, his/her details are passed to the requestor along with the preferred contact modality. Driving or walking directions is provided between the two parties, the requestor and the responding helper, if providing directions is requested in the configuration/setup menu. All data including category, contact attribute list, access configuration and contact configuration of each contact is stored and located in server 106 as shown in FIG. 1.

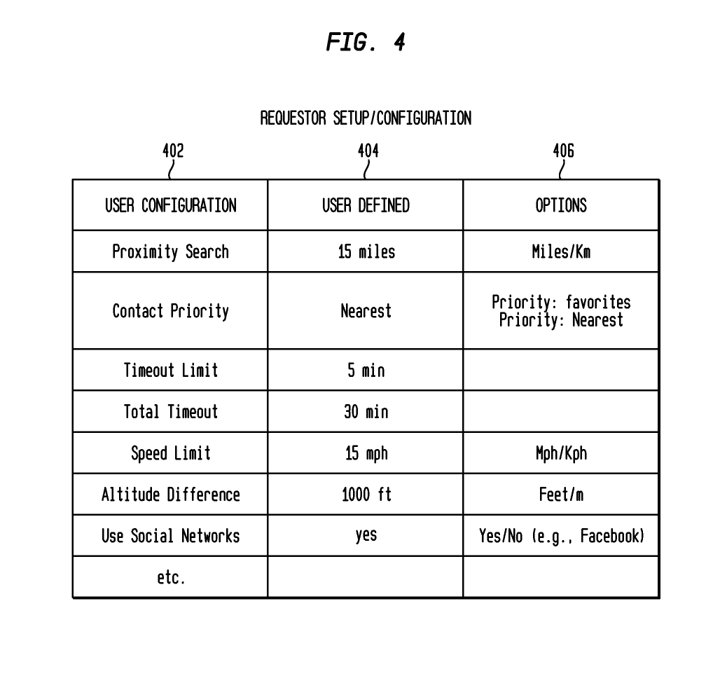

FIG. 4 shows an exemplary list of a requestor's setup/configuration list of limitations for assistance requests from nearby contacts in accordance with embodiments of the invention. As shown, requestor setup includes requestor configuration 402, requestor defined time interval 404, and options 406. Requestor configuration 402 includes proximity search, contact priority, timeout limit, total timeout, speed limit, altitude difference, use of social networks, etc. Requestor defined time interval 404 may be defined by requestor's preference. For example, the requestor may define a timeout limit as 5 minutes and a total timeout 30 minutes. The requestor's setup and configuration are stored and located in server 106 as shown in FIG. 1.

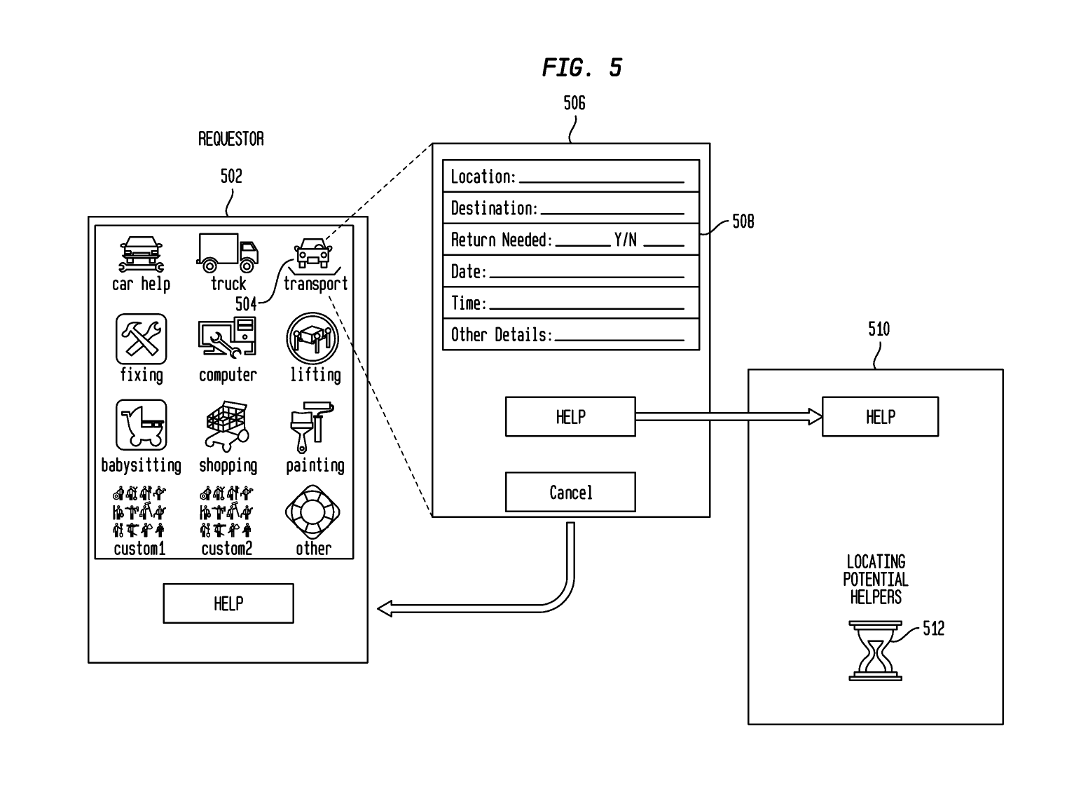

FIG. 5 shows an exemplary “screen shot” of a requestor's device display when a request is placed in accordance with embodiments of the invention. In the described embodiments, the requestor's device may a smartphone, a tablet computer, or a laptop computer, or the like. An exemplary request is made on requestor's display 502 by the requestor selecting icon 504 that represents a type of help that the requestor needs. The type of help associated with an icon is also referred to herein generically as a keyword since the type of help is text string or a codeword representing the type of help. Some typical icons that the requestor uses often are displayed on display 502, for example, car help, truck, transport, fixing (e.g., house repair), computer help, lifting, babysitting, shopping, painting, etc. As shown in FIG. 5, when a transport request is placed, window 506 pops up. Window 506 includes table 508 listing location, destination, return needed, date, time, and other details of the request. In one embodiment, the requestor inputs the requestor's scenario onto table 508 and then clicks on HELP button, HELP window 510 pops up and timer 512 starts to count. In another embodiment, the requestor clicks on the Cancel button in window 506 to return to display 502. Operation of the display 502, window 506, and window 510 are controlled by the server 106 (FIG. 1). Contents of table 508 are also stored in server 106 shown in FIG. 1.

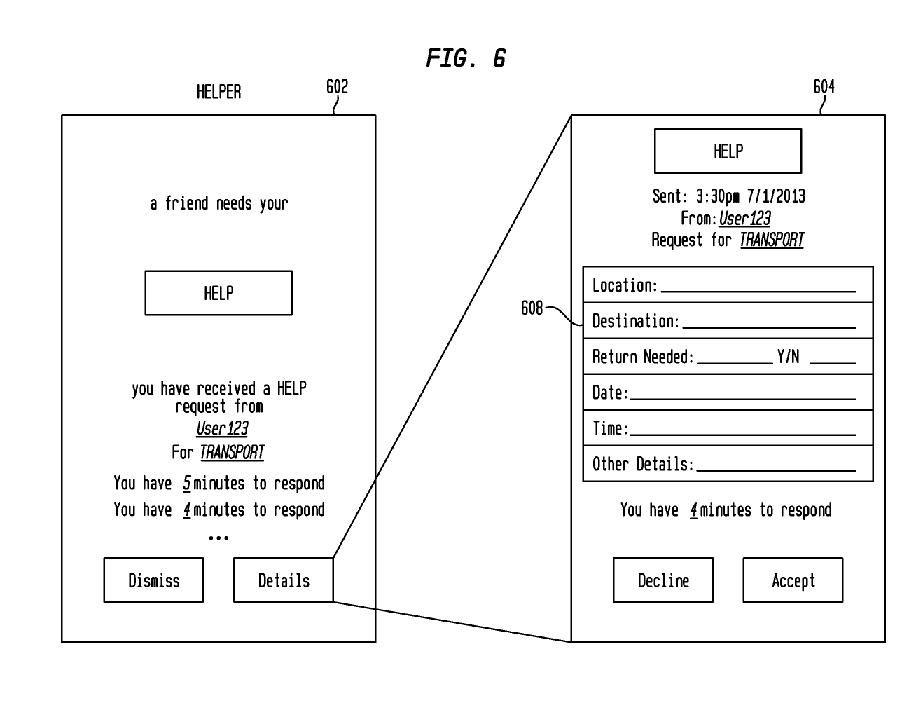

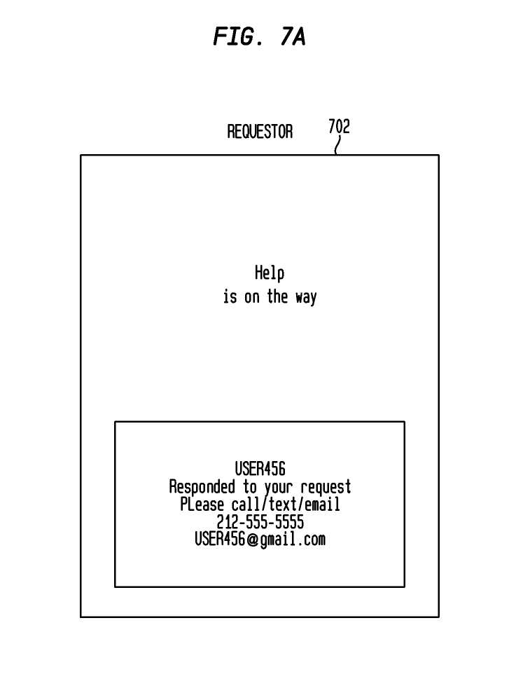

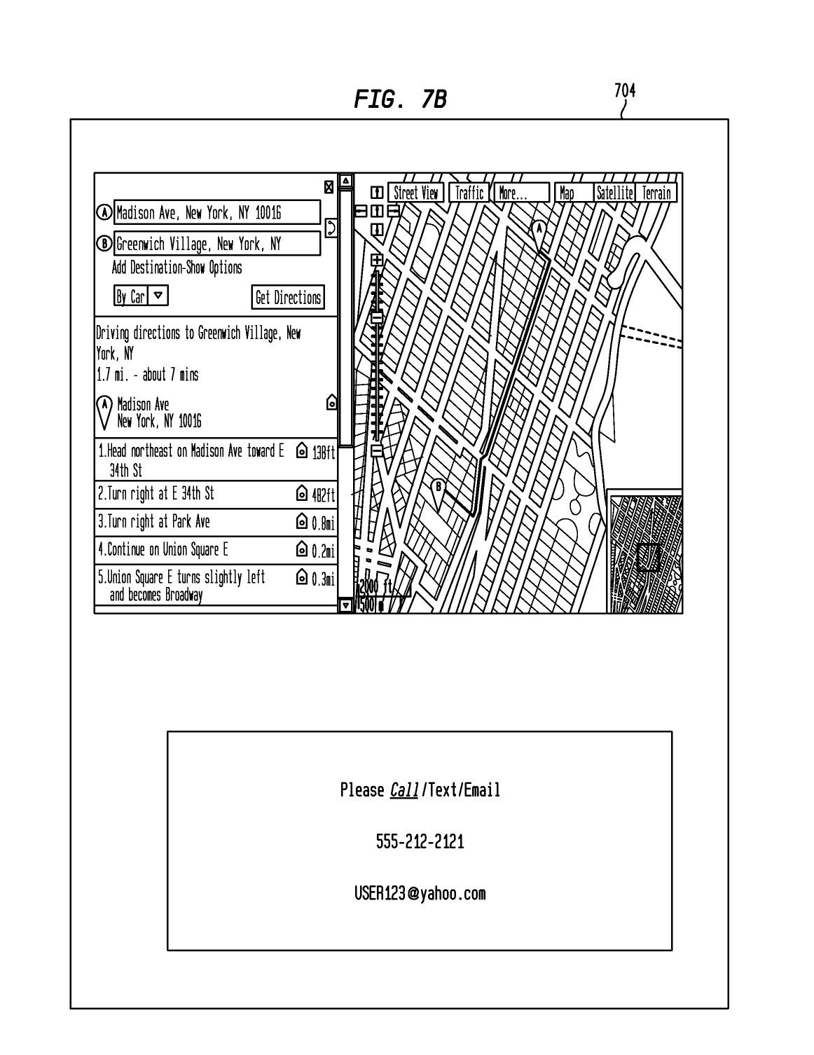

FIG. 6 shows an exemplary “screen shot” of a potential helper's device display when a request is placed in accordance with embodiments of the invention. In the described embodiments, the potential helper's device might be a smartphone, a tablet computer, a desktop computer, or the like. As shown in FIG. 6, a potential helper receives the exemplary help request message on display 602. When a request is placed by the requestor, the request is sent to the closest viable contact selected from requestor's contacts stored in the server unless the requestor's preference dictates that a “favorite” contact (if available) should be chosen before the closest contact. An exemplary message such as “a friend needs your HELP” pops up on display 602 of the contacted party's device as shown in FIG. 6. Display 602 also shows who is requesting HELP, purpose of the request, and a time period within which to respond. “Details” and “Dismiss” buttons are also displayed on display 602. The potential helper may choose to select either “Dismiss” or “Details” button. If the “Dismiss” button is selected, it means that this potential helper cannot provide help. If the “Details” button is selected, HELP window 604 pops up showing details of the request including table 608 that lists location, destination, return needed, date, time, and other details of the request. Here, table 608 is the same as table 508 shown in FIG. 5. HELP window 604 also indicates remaining time left to respond, for example, as shown in FIG. 6, there are 4 minutes left to respond to this request. This potential helper may refuse to help or offer to help by selecting the “Decline” or “Accept” button respectively, as displayed on the HELP window 604. If the “Accept” button is selected by this potential helper, the requestor receives a message on his/her display, as shown in FIG. 7A. Operations of display 602 and window 604 are under control of the server 106 shown in FIG. 1. Contents of table 608 are also stored in server 106 shown in FIG. 1.

FIG. 7A shows an exemplary “screen shot” of a requestor's device display when the request for HELP is accepted by a helper in accordance with embodiments of the invention. A message that “HELP is on the way” or the like along with the helper's name, contact method, phone number, and email address appears on requestor's display 702. FIG. 7B shows an exemplary “screen shot” of a helper's device display 704 when a request is accepted by the helper in accordance with embodiments of the invention. Helper display 704 includes the requestor's contact information including the requestor's phone number and email address along with preferred means of communicating. Based on the helper's preference settings, a map showing the locations of the requestor and helper along with the driving/walking directions are displayed. Operations of display 702 and window 704 are executed by the server 106 shown in FIG. 1. All information displayed on display 702 and window 704 is also stored in server 106 shown in FIG. 1

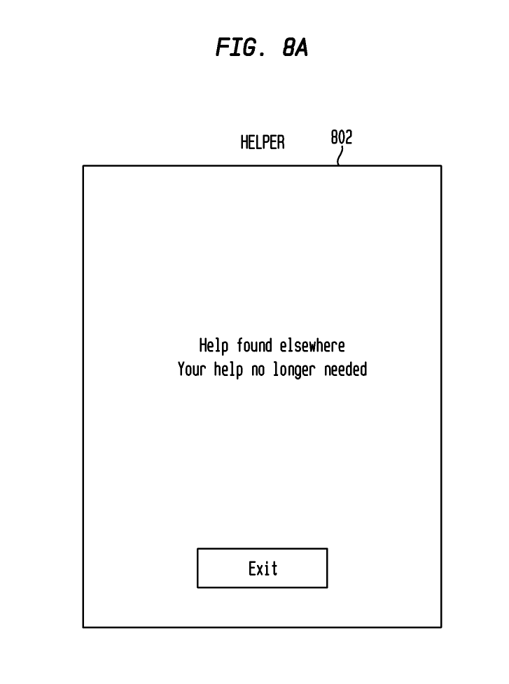

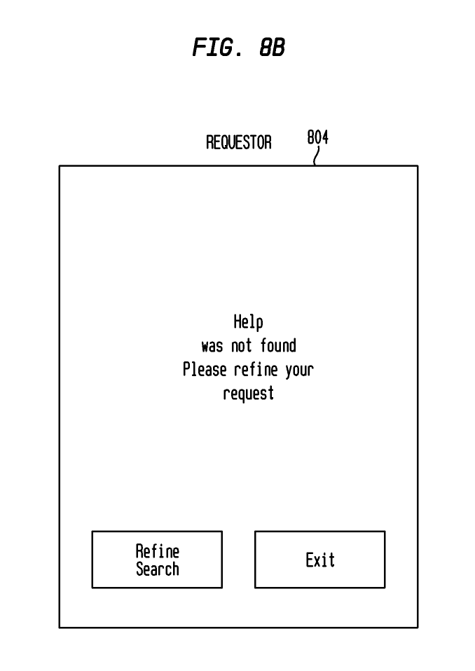

FIG. 8A shows an exemplary “screen shot” of previously contacted helpers display 802, when a request is addressed by a helper in accordance with embodiments of the invention. When one of the contacted potential helpers accepts the request for help, all other previously contacted potential helpers each receive a message that “HELP found elsewhere, your help no longer needed” or the like. This operation is performed by the server 106 shown in FIG. 1.

FIG. 8B shows an exemplary “screen shot” of a requestor's device display when no helper can be found in accordance with embodiments of the invention. In an alternative embodiment, if no helper can be found, then the requestor can refine his/her search or exiting the application. As shown in FIG. 8B, a message of “HELP was not found please refine your request” pops up on requestor's display 804. By selecting the “Refine Search” button, the requestor may continue to look for other potential helpers with an option to expand his/her search range, modify criteria, etc. Alternatively, the requestor can exit the application by selecting the “Exit” button and then finding other means of summoning help. This operation is performed by the server 106 shown in FIG. 1.

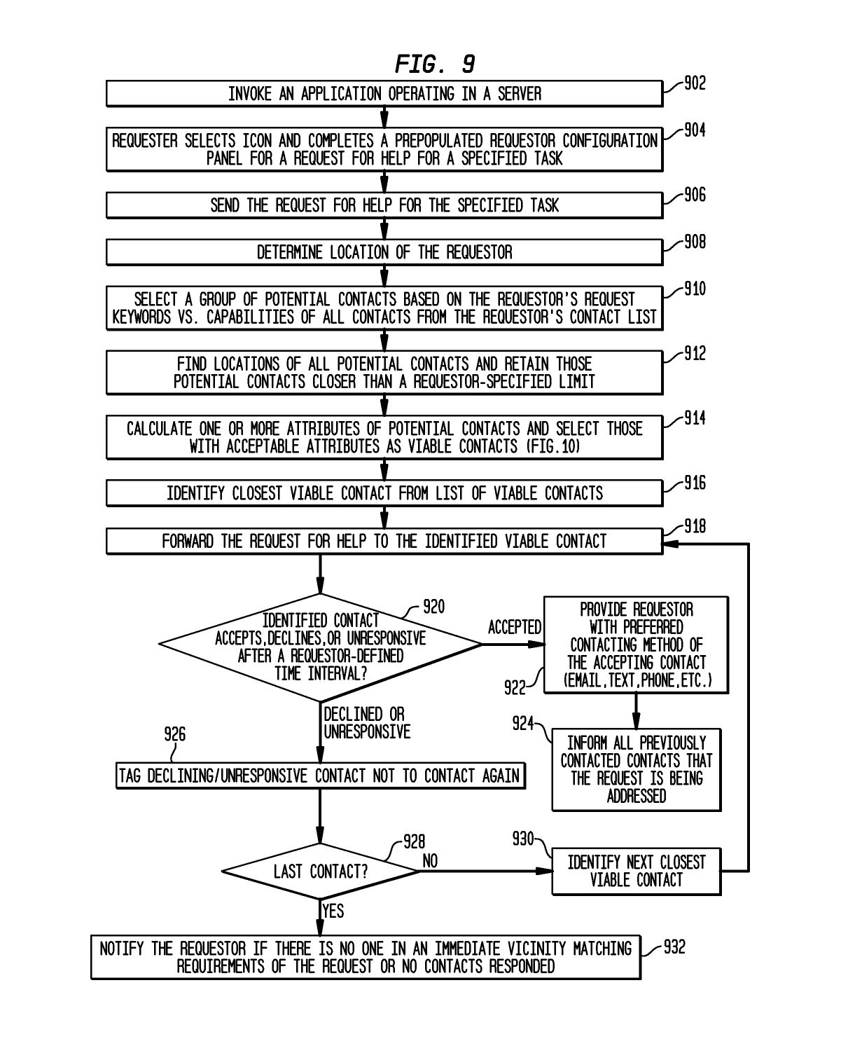

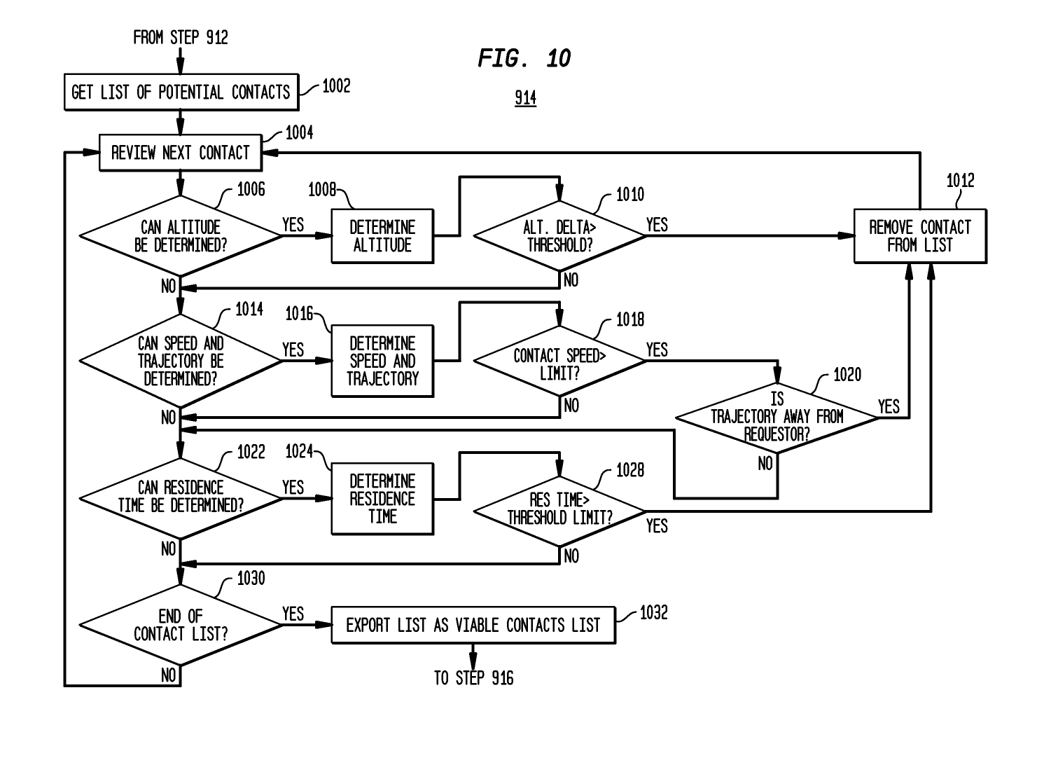

FIG. 9 shows a flowchart of an exemplary method for requesting for help through the system shown in FIG. 1 in accordance with embodiments of the invention. As shown, at step 902, a requestor invokes an application operated in a server for a request for help for a specified task. At step 904, the requestor selects an icon corresponding to the help needed and then completes a prepopulated table (e.g., 508 in FIG. 5) to request help for a specific task, and then in step 906 sends the request for specified help to the server 106. At step 908, the application determines the location and altitude (if possible) of the requestor that will be compared to those of the chosen contacts. During step 910, a group of potential contacts is selected by the server based on the requestor's requirements or keywords vs. capabilities of all contacts from the requestor's potential helper list. At step 912, the application locates positions of all potential contacts found in step 910 and using the requestor's proximity preference thresholds or limits (see, for example, FIG. 4) retains those potential contacts that fall within those limits. Locations of the selected contacts may be found using GPS coordinates, well-known cell site-based triangulation, or information from websites such as Facebook, Google+ that makes available their users' “checked in” status. Preferred location identification is by GPS or cell site triangulation techniques. In another embodiment, at step 912, the closest contact is identified using a requestor's favorite contact list instead of a generic list. At step 914, the server determines a set of viable helpers based on calculated attributes of the potential contacts. As described in more detail in FIG. 10, the server calculates certain attributes of the potential contacts, such as speed, altitude, and trajectory with respect to the requestor's physical position, and a “checked in” residence time, and compares the calculated results with certain requestor-defined thresholds or limits to determine if the potential contacts meet the requirement of viable helpers, and those potential contacts that meet the thresholds or limits are placed on a list of viable contacts. At step 916, the closest one of the viable contacts is identified and in step 918 the server forwards the request for help to the viable contact (the viable helper), in this instance the request is sent to the viable contact closest to the requestor. At step 920, once the request for help reaches the identified viable contact, that contact may respond in one of the following ways: accept, decline, or not respond during a requestor-defined time limit. If the identified viable contact indicates that he/she accepts the requestor's request for help, then at step 922 the accepting contact's preferred method of communication (e.g., by email, text, telephone call, etc.) is provided to the requestor. Once a contact has acknowledged willingness to help, previously contacted persons, if specified in their configuration, are informed that their help is no longer needed at step 924.

If, however, the determined contact declines or remains unresponsive after the requestor-defined time has elapsed, at step 926 the declining/unresponsive contact is optionally tagged as not to be contacted again if the requestor repeats his/her request for help. Then, at step 928 it is determined if there are more viable contacts to be tried and, if so, control passes to step 930 where the next closest one of the viable contacts is determined and control passes back to step 918 so that the request is sent to the next closest viable contact. If, however, no more viable contacts remain, then control passes to step 932 where the server notifies the requestor that there is no help available in the requestor-defined proximity and matching the requirements of the request was found. The requestor can then choose to modify the search parameters or exit the application (see, for example, FIG. 8B).

In an alternative embodiment, the requestor might optionally have the server 106 sequentially contact the contacts again if no contact accepted the requestors help request.

FIG. 10 shows a more detailed flowchart of an exemplary method for the step 914 of FIG. 9. Here, attributes of the selected contacts are calculated by the server 106 shown in FIG. 1. In the steps of FIG. 10, the application takes all potential contacts determined in step 912 of FIG. 9 and creates therefrom a list of all viable contacts. An attribute for determining whether a potential contact should be considered viable includes at least one of the following: speed, trajectory, altitude, and residence time. In one embodiment, the following steps calculate the attributes for each of the potential contacts and compares the calculated attributes with certain requestor-defined thresholds or limits to determine whether or not each of the selected contacts meets the requirements of a potential helper, and those potential contacts that do not meet the thresholds or limits are removed from the list of potential contacts.

In step 1002, the list of potential contacts is obtained. Then at step 1004, the application begins the process of determining the speed, altitude, trajectory, residence time of all potential contacts that can be determined beginning, at this point, with the first contact on the potential contact list from step 1002. In step 1006, if it is possible to determine the altitude of the contact being analyzed and the requestor, then control passes to step 1008 in which the altitude of the contact is determined. Then in step 1010 the difference between the altitude of the contact and the altitude of the requestor (from step 908) is compared to the requestor-defined limit. If the difference in altitude (delta) is greater than the limit, then the contact is not a viable contact and it is removed from the list in step 1012 and then control passes back to step 1004 where the next contact on the list is evaluated.

Returning to step 1010, if the altitude delta is less than the limit, then in step 1014 if it is possible to determine the speeds and trajectories of the contact, then control passes to step 1016 in which the speed and trajectory of the contact is determined. Next, in step 1018, if the speed of the contact is greater than a speed limit set by the requestor, then control passes to step 1020 where the trajectory of the contact is compared to the requestor's position to see if the contact's trajectory is away from the requestor or not. If the trajectory is away from the requestor, then control passes to previously described step 1012. If the speed is less than the speed limit (step 1018), in which case the contact is moving slowly enough so that it could be confirmed as a viable contact, or if the trajectory of the contact is not away from the requestor (step 1020), then control passes to step 1022. In this embodiment, is assumed that the requestor is not moving; in another embodiment, the requestor is moving and as such the speed being checked in step 1018 and the trajectory in step 1020 might be made relative to the speed and instantaneous position of the requestor, respectively.

In step 1022, if it is possible to determine the residence time of the contact, then control passes to step 1024 where the residence time of the contact is determined. As used here, the time a contact identified as being proximate a location solely based on social website information is the residence time of the contact. Then in step 1026, if the residence time of the contact is greater than a requestor-specified limit, then control passes to the previously described step 1012, otherwise control passes to step of 1030. Steps 1022-1026 serve to remove those contacts on the list of potential contacts that have an extended residence time. For example, someone who visits a restaurant and “checks in” but appears to remain there for unreasonably extended periods of time (e.g., more than one day) has an unreasonable extended residence time. Even though this contact might be close to the requestor, he/she is excluded from the list of the potential contacts and control passes to step 1030.

In step 1030, the list of contacts is checked to see if the final one of the contacts has been evaluated and if not, then control passes back to step 1004 and the next contact on the list of contacts is analyzed as described above. If, however, the final contact has been analyzed, then in in step 1032 the contacts remaining on the list from step 1002 is a set of viable contracts for the particular request made by the requestor and that list is exported as a list or set of viable contacts. Then control passes to step 916 in FIG. 9 as described above.

In this embodiment, if the speed, altitude, and trajectory of any of the selected contacts cannot be determined, then the method, by virtue of steps 1006, 1014, and 1022, does not remove those contacts from the list of contacts and, thus, treats them as viable contacts. Instead of treating those contacts as viable contacts by default, in another embodiment the steps in FIG. 10 are modified so that those contacts are instead removed from the list in step 1012.

In an alternative embodiment, instead of deleting contacts that do not meet the requestor-specified limits or thresholds, contacts are added to form a list of viable contacts that satisfies the requestor-specified limits or thresholds. Using either technique, the process described above selects, from the one or more contacts having a calculated attribute, a set or list of one or more viable contacts based on a comparison between the calculated attribute and a requestor-defined limit or threshold.

As described here, the contacts retain their anonymity by default until they respond with their agreements to help. The requestor and other contacts would never know who was contacted and who was available but ignored the call for help.

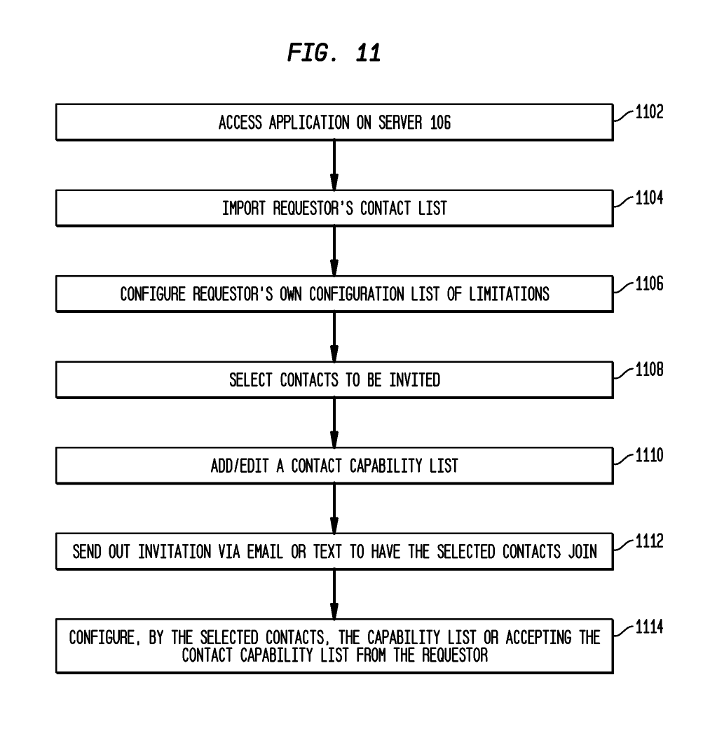

FIG. 11 shows a flowchart of installation and initial setup of the system shown in FIG. 1 in accordance with embodiments. At step 1102, a requestor accesses the application running on the server 106 (FIG. 1) using a device, for example, a smartphone, tablet computer, a laptop computer, or the like. Then at step 1104, the application imports the requestor's contact list from the requestor's device. At step 1106, the requestor configures his/her setup to specify the search parameters and limitations when requesting help (see FIG. 4, Requestor Setup/Configuration table). At step 1108, the requestor adds or selects a group of contacts from the requestor's contact list to be invited and may be willing to be included in a requestor potential helper list (e.g., FIGS. 3A-3C). This group of the contacts may be a selection of the requestor's family, friends, colleagues, and neighbors from the requestor's contact list. At step 1110, the requestor adds/edits a contact capability list corresponding to the requestor's potential helper list for a request for help for a specified task. At step 1112, the application sends out invitation via email or text to have the selected contacts join the requestor's potential helper list. Next, at step 1114, when the selected contacts accept the invitation, the selected contacts may edit the attributes list by themselves or accept the original requestors' capability list.

The described embodiments provide a non-emergency help system that is anonymous, sequential, and matches capabilities of the helpers to the requestor's needs. Helpers identify the type of assistance they could or would be willing to provide/fulfill and then agree to become available anonymously and are sequentially located during a request for assistance that matches their capabilities and proximity to the requestor and, upon their agreement to comply to the request, then made visible to the requestor. The nearest helper may choose to respond or decline the request. This anonymous location process occurs sequentially awaiting a requestor-defined timeout, until one of the identified individuals agrees to fulfill the request or until there are no other individuals proximate that meet the specific request criteria. A call for help is not broadcast, but contacts are chosen based on their disclosed skills/capabilities and their proximity to the requestor. Examples of capability-based help requests could include but not limited to a requestor's situations, such as, car needs a jumpstart, being locked out of the house, needing help moving heavy objects, requiring babysitting services, needing truck to transport a large item, requiring minor home plumbing help/expertise, etc.

The described embodiments also provide feedback to the requestor and the potential helpers. The feedback is provided to the requestor or the requestor and anonymously to the potential helpers. If one individual does agree to comply with the request, all of the other individuals previously contacted are notified that the request is being fulfilled. If the list of potential candidate helpers is exhausted and/or no complying individuals found, the requestor is notified that there are no individuals proximate and given the option to expand their search range, modify criteria, etc. If a helper agrees to comply with a request, a message with the preferred direct contact information (phone call, text, email, etc.) is provided to the helper. An additional embodiment allows for a requestor-specified preference of contacting key or favorite individuals (e.g. family) over the next nearest proximate helpers in, for example, steps 916 and 930.

Contacts identified as being proximate solely from geo-social networking location applications or geo-social networking website information (collectively referred to as geo-social networking) may be excluded based on excessive “residence time” such as, for example, when someone visits a restaurant and “checks in” there but appears to remain there for an unreasonable period of time (e.g., 1 days).

Speed of the potential helpers is determined to eliminate contacts that may appear within the specified proximity of the requestor. Travelling on an airplane precludes those contacts from being selected as potential helpers.

Contacts travelling at a trajectory towards the requestor, at normal driving speeds may, however, qualify as suitable potential helpers.

The described embodiments rely on existing available means for determining the speed and trajectory of the contacts. These may include utilizing Doppler shifts or calculating a change in location over time.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, or apparatus.

While the exemplary embodiments have been described with respect to processes implemented by a server or the like, the embodiments are not so limited. As would be apparent to one skilled in the art, various functions of the server as described herein might also be implemented by distributed processes executed by physically diverse systems, such as other smartphone devices.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

It will be further understood that various changes in the details, materials, and arrangements of the parts which have been described and illustrated in order to explain the nature of described embodiments may be made by those skilled in the art without departing from the scope as expressed in the following claims.

1. A method comprising the steps of:
receiving, from a requestor, a request for assistance for a specified task;
selecting, from a list of contacts, contacts based on the request for assistance for the specified task using keywords of the request compared against capabilities of the contacts on the list of contacts;
determining physical locations of the requestor and one or more of the selected contacts;
identifying, from the selected contacts, one or more potential contacts based on physical distance between the one or more selected contacts and the requestor;
calculating an attribute for each of the one or more potential contacts having a determined physical location;
selecting, from the one or more potential contacts having a calculated attribute, a set of one or more viable contacts based on a comparison between the calculated attribute and a requestor-defined limitation; and
forwarding the request for assistance to the one or more selected viable contacts;
wherein the attribute is at least one of:
i) speed of the potential contact having a determined physical location,
ii) trajectory of the potential contact having a determined physical location with respect to the physical location of the requestor,
iii) altitude of the potential contact having a determined physical location with respect to the physical location of the requestor, and
iv) residence time of the potential contact at a determined physical location.

2. The method of claim 1 wherein the request for assistance is first forwarded to the selected viable contact that is physically closest to the requestor.

3. The method of claim 2 further comprising the steps of:
sequentially contacting subsequent selected viable contacts in order of increasing physical distance between the selected viable contact and the requestor if the contacted selected viable contact does not accept the request for assistance within a requestor-defined time interval; and
notifying the requestor if there is no selected viable contact or if no selected viable contact accepts the request for assistance.

4. The method of claim 3 further comprising the steps of:
receiving, from the selected viable contact, an acceptance of the request for assistance within the requestor-defined time interval;
providing at least one preferred method of contacting the accepting contact to the requestor; and
informing all previously contacted contacts that the request for assistance is being addressed.

5. The method of claim 1 wherein an order in which the request for assistance is forwarded to the selected viable contacts is based on a requestor-specified preference that specifies the order of contacting the selected viable contacts.

6. The method of claim 1 further comprising the steps of:
using as a default viable contact a potential contact if no attributes for the potential contact can be calculated; and
forming the list of the viable contacts from the default viable contacts.

7. The method of claim 1 wherein:
the step of calculating an attribute includes the step of determining if the potential contact has a physical location identified by geo-social networking, and
the step of selecting a list of viable contacts includes the step of adding the potential contact to the set of viable contacts if a residence time of the viable contact at the determined physical location is less than a requestor-defined time limit.

8. The method claim 7 wherein the requestor-defined time limit is one day.

9. The method of claim 1 wherein:
the step of calculating an attribute includes the step of determining a speed of the potential contact and a trajectory of the potential contact with respect to the requestor, and
the step of selecting a set of viable contacts includes the step of adding the potential contact to the set of viable contacts if the speed is greater than a requestor-defined speed limit and the trajectory is not away from the requestor.

10. The method of claim 1 wherein:
the step of calculating an attribute includes the step of determining a speed of the viable contact, and
the step of selecting a set of viable contacts includes the step of adding the potential contact to the set of viable contacts if the speed is less than a requestor-defined speed limit.

11. The method of claim 1 wherein in the step of selecting a set of viable contacts, a potential contact is added to the set of viable contacts if all calculable attributes of the potential contact satisfy the requestor-defined limits.

12. The method of claim 1 wherein the method is performed on an Internet-coupled server.

13. The method of claim 11 further comprising the steps of:
importing, from an intelligent device controlled by the requestor, a set of contacts into the server; and
sending out invitations, at the requestor's behest, to contacts in the set of contacts a request to join the requestor's list of contacts.

14. The method of claim 12 further comprising the steps of:
creating a set of capabilities for each contact on the list of contacts; and
allowing each contact that responded to the invitations to change the capability set corresponding to the responding contact.

15. The method of claim 1 wherein the request for assistance is for a task chosen by the requestor from a list of tasks having keywords associated therewith.

16. The method of claim 1 wherein the step of determining the physical locations of the requestor and the one or more selected contacts and the step of calculating an attribute uses at least one of a global positioning system, cell site triangulation, and websites with geo-social networking.

17. An assistance request system, comprising:
a server, and
a communication network configured to communicate between the server and at least one requestor and at least one contact;
wherein the server is configured to:
receive, from a requestor, a request for assistance for a specified task;
select, from a list of contacts, contacts based on the request for assistance for the specified task using keywords of the request compared against capabilities of the contacts on the list of contacts;
determine physical locations of the requestor and one or more of the selected contacts;
identify, from the selected contacts, one or more potential contacts based on physical distance between the one or more selected contacts and the requestor;
calculate an attribute for each of the one or more potential contacts having a determined physical location;
select, from the one or more potential contacts having a calculated attribute, a set of one or more viable contacts based on a comparison between the calculated attribute and a requestor-defined limitation; and
forward the request for assistance to at least one of the one or more selected viable contacts;
wherein the attribute is at least one of:
i) speed of the potential contact having a determined physical location,
ii) trajectory of the potential contact having a determined physical location with respect to the physical location of the requestor,
iii) altitude of the potential contact having a determined physical location with respect to the physical location of the requestor, and
iv) residence time of the potential contact at a determined physical location.

18. The apparatus of claim 17 wherein the server is further configured to:
use stored default viable contacts if no attributes for the potential contacts can be calculated; and
form the list of the viable contacts from the default viable contacts.

19. The apparatus of claim 17 wherein in the step to calculate an attribute, the server is further adapted to determine if the potential contact has a physical location identified by geo-social networking, and the step to select a set of viable contacts the server is further adapted to add the potential contact to the set of viable contacts if a residence time of the potential contact at the determined physical location is less than a requestor-defined time limit.

20. The apparatus of claim 19 wherein the requestor-defined time limit is one day.

21. The apparatus of claim 17 wherein in the step to calculate an attribute the server is further adapted to determine a speed of the potential contact and a trajectory of the potential contact with respect to the requestor, and the step to select a set of viable contacts the server is further adapted to add the potential contact to the set of viable contacts if the speed is greater than a requestor-defined speed limit and the trajectory is not away from the requestor.

22. The apparatus of claim 17 wherein in the step to calculate an attribute the server is further adapted to determine a speed of the potential contact, and the step to select a set of viable contacts the server is further adapted to add the potential contact to the set of viable contacts if the speed is less than a requestor-defined speed limit.

23. The apparatus of claim 17 wherein in the step to determine a set of viable contacts the server is further adapted to add a potential contact to the set of viable contacts if all calculable attributes of the potential contact satisfy the requestor-defined limits.

24. A method comprising the steps of:
A) receiving, from a requestor, a request for assistance for a specified task;
B) selecting, from a list of contacts, contacts based on the request for assistance for the specified task using keywords of the request compared against capabilities of the contacts on the list of contacts;
C) determining physical locations of the requestor and one or more of the selected contacts;
D) identifying, from the selected contacts, one or more potential contacts based on physical distance between the one or more selected contacts and the requestor,
E) calculating an attribute for each of the one or more potential contacts having a determined physical location;
F) creating a list potential contacts from the one or more potential contacts having a calculated attribute;
G) removing potential contacts from the list of potential contacts based on a comparison between the calculated attribute and a requestor-defined limitation;
H) creating, after step G), a list of viable contacts from the list of potential contacts; and
I) forwarding, after step H), the request for assistance to at least one of the viable contacts in the set of viable contacts;
wherein the attribute is at least one of:
i) speed of the potential contact having a determined physical location,
ii) trajectory of the potential contact having a determined physical location with respect to the physical location of the requestor,
iii) altitude of the potential contact having a determined physical location with respect to the physical location of the requestor, and
iv) residence time of the potential contact at a determined physical location.

25. The method of claim 24 wherein the method is performed on an Internet-coupled server.

26. The method of claim 24 further comprising the steps of:
importing, from an intelligent device controlled by the requestor, a set of contacts into the server; and
sending out invitations, at the requestor's behest, to contacts in the set of contacts a request to join the requestor's list of contacts.

27. The method of claim 26 further comprising the steps of:
creating a set of capabilities for each contact on the list of contacts; and
allowing each contact that responded to the invitations to change the capability set corresponding to the responding contact.

28. The method of claim 24 wherein:
step E) includes the step of determining if the potential contact has a physical location identified by geo-social networking, and
step G) includes the step of removing the potential contact from the list of potential contacts if a residence time of the potential contact at the determined physical location is more than a requestor-defined time limit.

29. The method claim 28 wherein the requestor-defined time limit is one day.

30. The method of claim 24 wherein:
step E) includes the step of determining a speed of the potential contact and a trajectory of the potential contact with respect to the requestor, and
step G includes the step of removing the potential contact from the list of potential contacts if the speed is greater than a requestor-defined speed limit and the trajectory is away from the requestor.

31. The method of claim 24 wherein in step G), a potential contact is removed from the list of potential contacts if any of the calculable attributes of the potential contact do not satisfy the requestor-defined limits.
